(19) United States
(12) Patent Application Publication
(10) Pub. No.: US 2020/0074267 A1
(43) Pub. Date: Mar. 5, 2020

(54) DATA PREDICTION

(71) Applicant: INTERNATIONAL BUSINESS MACHINES CORPORATION, ARMONK, NY (US)

(72) Inventors: Hitham Ahmed Assem Aly Salama, Dublin (IE); Faisal Ghaffar, Dunboyne (IE); Teodora S. Buda, Dublin (IE); Bora Caglayan, Dublin (IE)

(21) Appl. No.: 16/119,194

(22) Filed: Aug. 31, 2018

(51) Int. Cl. G06N 3/04; G06N 3/08

(52) U.S. Cl. CPC G06N 3/04; G06N 3/08

(57) ABSTRACT

Various embodiments are directed to concepts for spatio-temporal prediction based on one-dimensional features and two-dimensional features from diverse data sources. One embodiment comprises processing one-dimensional data matrices representative of variations of one-dimensional, 1D, feature values with a fully connected network to generate respective outputs from the fully connected network. It also comprises processing two-dimensional data matrices representative of variations of two-dimensional, 2D, feature values with a convolutional neural network to generate respective outputs from the convolutional neural network. The outputs from the fully connected network and convolutional neural network are combined, in a data fusion layer, to generate an output prediction

### FIELD

Embodiments of the present invention relate to data prediction, and more particularly to a method that may be suitable for spatio-temporal prediction.

### BACKGROUND

The project leading to this application has received funding from the European Union's Horizon 2020 research and innovation programme under Grant Agreement No. 671625.

Various data sources are becoming increasingly available as a result of the continued developments in digital data storage and communication systems. However, the increasing number and variety of data sources pose difficulties in making use of such diverse data sources, particularly for the purpose of forecasting or predicting data values that are dependent on multiple variables (such as time and space/location for example).

By way of example, it may be proposed that regions in cities, weather data, individuals' mobility data, and other data sources are related to energy demand. The challenge, however, is to be able to make sense of these diverse data sources, especially where the data sources are of differing dimensionalities. Making sense of such diverse data may, however, enable relationships between the data to be derived, which may, in turn, enable prediction of future energy demand.

### SUMMARY

Embodiments of the present invention seek to provide a concept for data prediction that can employ data from diverse data sources. Such a concept may, for example, be suitable for spatio-temporal prediction from diverse data sources. Embodiments of

Embodiments of the present invention further seek to provide a computer program product including computer program code for implementing the proposed prediction concepts when executed on a processor.

Embodiments of the present invention yet further seek to provide a processing system adapted to execute this computer program code.

According to an embodiment of the present invention there is provided a method for spatio-temporal prediction based on one-dimensional features and two-dimensional features from diverse data sources. The method comprises, for each of one or more one-dimensional, 1D, features, obtaining a one-dimensional data matrix representative of a variation of the 1D feature value. The method also comprises, for each of one or more two-dimensional, 2D features, obtaining a two-dimensional data matrix representative of a variation of a 2D feature value. The method further comprises processing each one-dimensional data matrix with a branch of a fully connected network to generate respective outputs from the fully connected network, and processing each two-dimensional data matrix with a convolutional neural network to generate respective outputs from the convolutional neural network. The method yet further comprises combining, in a data fusion layer, the outputs from the fully connected network and convolutional neural network to generate an output prediction.

According to various embodiments, there is proposed a concept which employs a branch of a Fully-Connected Network (FCN) to process one-dimensional data (e.g. a time dependent data series) and also employs a Convolutional Neural Network (CNN) to process two-dimensional data (e.g. data dependent on time and space/location). Predictions provided by the FCN and CNN may then be fused (i.e. combined) to provide a final, output prediction.

In this way, proposed embodiments may, for example, provide a deep-learning-based architecture that may be of particular use for spatio-temporal data prediction.

According to various embodiments, there may be proposed the concept of employing convolutional-based dense networks for modelling dependencies between data that is dependent on multiple variables (such as time and space/location for example). In this way, temporal and spatial dependencies (e.g. between regions in cities) may be modelled and used for predictions.

According to various embodiments, proposed concepts may also employ several branches for fusing various external data sources of differing dimensionalities. In this way, a proposed architecture may be expandable according to the availability of the external data sources that need to be fused.

Such proposals have been applied and tested on a network demand prediction problem to prove its improved performance when compared to conventional prediction concepts. In particular, a proposed embodiment has been evaluated on real network data extracted from New York City (and more specifically Manhattan) over the period of six months. The obtained results confirm the advantages of the embodiment when compared to four other conventional prediction approaches.

By way of further example, embodiments may provide a deep-learning-based approach for forecasting the spatio-temporal continuous values in each and every region of a city or a grid map. Such a deep-learning-based architecture may fuse external data sources of various dimensionalities (such as temporal functional regions, crowd mobility patterns, and weather data in case of Network demand prediction problem) and may improve the accuracy of the forecasting. Compared to techniques employed in various conventional approaches, proposed embodiments provide better performance (in terms of prediction accuracy for example), thus confirming that embodiments may be better and more applicable to spatio-temporal time series forecasting problems.

According to various embodiments, proposed concepts may learn from multi-modalities using deep-learning which is mainly focused on fusing (i.e. combining) different types of data sources (e.g. from different modalities) such as text, speech and audio. Embodiments may be focused on approaches for fusing multi-dimensional data sources (e.g. 1D and 2D data sources) and making sense of these diverse data sources by employing parallel neural networks. In particular, a respective FCN branch may be employed for each ID data source, and 2D data sources may be processed by a CNN. An exemplary 1D data source may, for instance, comprise weather data that changes with respect to time only. An exemplary 2D data source may, for instance, comprise crowd counts that change with time across regions in cities. Accordingly, a deep-learning-based architecture for spatio-temporal prediction may be provided which fuses (i.e. combines) various data sources.

Proposed embodiments may be embedded as a service for solving a particular prediction problem.

In an embodiment, a one-dimensional data matrix may be representative of a variation of a 1D feature value with respect to time or space, and a two-dimensional data matrix may be representative of a variation of a 2D feature value with respect to time and space. Accordingly, proposed embodiments may be capable of learning spatial and temporal dependencies. Such embodiments may thus provide the advantage of providing a generic solution for any time-series forecasting spatio-temporal problem.

In some embodiments, different branches of a FCN may be used for different one-dimensional data sources. Also, different one-dimensional data matrices may be obtained from different data sources. Embodiments may therefore employ various parallel branches of a FCN for fusing external data sources.

Some embodiments comprise processing different two-dimensional data matrices with different CNNs. Also, different two-dimensional data matrices may be obtained from different data sources. Parallel CNNs may thus be employed for different two-dimensional data sources, and the outputs from the CNNs may then be fused. A concept of processing various two-dimensional data sources with parallel CNNs may thus be employed by embodiments.

In some embodiments, the step of combining may comprise weighting the outputs from the fully connected network and convolutional neural network. For example, the relative importance of the various predictions provided by the FCN and/or CNNs may be accounted for by applying weighting factors to the outputs from the FCN and/or CNNs. For instance, greater weighting may be applied to more important or more informed predictions, thus ensuring fusion of the data predictions is undertaken in a more appropriate and/or accurate manner.

In an embodiment, the method may further comprise processing the output prediction with a transformation function having an output range limited to predetermined range so as to translate the output prediction to a value within the predetermined range. For example, the predetermined range may be [4, 1] and the function may therefore be one of sin, cos and tanh. This may help to provide faster convergence in back-propagation learning compared to a standard logistic function.

Some proposed embodiments may further comprise: obtaining a two-dimensional training matrix representative of an historical variation of a 2D feature value; processing the two-dimensional training matrix with first to third machine learning processes to determine a trend, periodicity and closeness measure, respectively; and determining a training prediction based on the determined trend, periodicity and closeness measure. The output prediction may then be determined further based on the training prediction. In an exemplary embodiment, at least one of the first to third machine learning processes may comprise: applying a convolution process to the two-dimensional training matrix. The two-dimensional training matrix may, for example, be representative of a historical variation of the 2D feature value with respect to time and space. By way of example, a training matrix may be provided as a two-channel image-like matrix and this may be fed into branches of a neural network for capturing a trend, periodicity, and closeness. Each of the branches may start with convolution layer followed by L dense blocks and finally another convolution layer. Such convolutional-based branches may, for example, capture the spatial dependencies between nearby and distant regions.

According to another embodiment of the present invention, there is provided a computer program product for spatio-temporal prediction based on one-dimensional features and two-dimensional features from diverse data sources, the computer program product comprising a computer readable storage medium having program instructions embodied therewith, the program instructions executable by a processing unit to cause the processing unit to perform a method according to one or more proposed embodiments when executed on at least one processor of a data processing system.

According to yet another aspect, there is provided a processing system comprising at least one processor and the computer program product according to one or more embodiments, wherein the at least one processor is adapted to execute the computer program code of said computer program product.

According to yet another aspect of the invention, there is provided prediction system for spatio-temporal prediction based on one-dimensional features and two-dimensional features from diverse data sources. The system comprises an interface component configured to obtain, for each of one or more one-dimensional, 1D, features, a one-dimensional data matrix representative of a variation of the 1D feature value, and to obtain, for each of one or more two-dimensional, 2D, features, obtaining a two-dimensional data matrix representative of a variation of a 2D feature value. The system also comprises a first neural network component configured to process each one-dimensional data matrix with a branch of a fully connected network to generate respective outputs from the fully connected network. The system further comprises a second neural network component configured to process each two-dimensional data matrix with a convolutional neural network to generate respective outputs from the convolutional neural network. The system yet further comprises a data fusion component configured to combine the outputs from the fully connected network and convolutional neural network to generate an output prediction.

Thus, there may be proposed a prediction concept which may employ a number of neural network branches that are used to fuse external factors based on their dimensionality. For example, temporal functional regions and the crowd mobility patterns may comprise two-dimensional matrices that change across space and time. Conversely, the day of the week is one-dimensional matrix that changes across time only. According to a proposed embodiment, two-dimensional matrices may be processed with CNNs, whereas each one-dimensional matrix may be processed using a respective branch of a FCN.

### BRIEF DESCRIPTION OF THE DRAWINGS

Preferred embodiments of the present invention will now be described, by way of example only, with reference to the following drawings, in which:

FIG. 1 depicts a pictorial representation of an example distributed system in which aspects of the illustrative embodiments may be implemented;

FIG. 2 is a block diagram of an example system in which aspects of the illustrative embodiments may be implemented;

FIG. 3 is a simplified block diagram of a prediction system for spatio-temporal prediction according to an embodiment;

FIG. 4 depicts a schematic block diagram of a proposed embodiment;

FIG. 5 is simplified flow-diagram of a computer-implemented method for spatio-temporal prediction according to an embodiment; and

FIG. 6 illustrates a system according to another embodiment.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms

Also, in the context of the present application, a (processing) system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Various data sources are becoming increasingly available as a result of the continued developments in digital data storage and communication systems. However, the increasing number and variety of data sources poses difficulties in making use of such diverse data sources, particularly for the purpose of forecasting or predicting data values that are dependent on multiple variables (such as time and space/location for example).

By way of example, it may be proposed that regions in cities, weather data, individuals' mobility data, and other data sources are related to energy demand. The challenge, however, is to be able to make sense of these diverse data sources, especially where the data sources are of differing dimensionalities. Making sense of such diverse data may, however, enable relationships between the data to be derived, which may, in turn, enable prediction of future energy demand.

The concept of ‘deep learning’ has been applied successfully in many data analysis and prediction applications, and is currently considered to be a promising technique in the field of Artificial Intelligence (AI). There are two main types of deep neural networks that try to capture spatial and temporal properties, namely: a) Convolutional Neural Networks (CNNs) for capturing spatial structure and dependencies. b) Recurrent Neural Networks (RNNs) for learning temporal dependencies.

However, it remains difficult to apply such AI techniques to the forecasting data values that are multi-dimensional (i.e. dependent on multiple variables, such as time and space/location for example).

Embodiments are based on the insight that machine learning processes may be employed to analyze data relating to one-dimensional features and two-dimensional features from diverse data sources. Known artificial intelligence components (such as artificial neural networks or recurrent neural networks) may therefore be leveraged in conjunction with data fusing (combining) concepts so as to generate output predictions that account for multiple variables/factors (such as space and time for example).

It will be appreciated that the machine learning processes employed by proposed embodiments may be trained by historical data and/or feedback information. For instance, for training of an artificial neural network (such as a FCN or CNN) actual results or readings may be provided to the artificial neural network for assessment against generated output predictions.

It will be understood that proposed Artificial Intelligence (AI) employed by the proposed machine learning processes may be built upon conventional or known AI architectures. The proposed machine learning processes may improve conventional or known AI architectures. Accordingly, detailed discussion of specific AI implementations is omitted for the sake of brevity and/or clarity of the proposed concepts detailed herein. Nonetheless, purely by way of example and completeness, it is noted that proposed embodiments may employ FCNs and CNNs. Branches of a FCN may be used to process one-dimensional data representative of a variation of a 1D feature value (e.g. a time dependent data series), whereas a CNN may be used to process two-dimensional data representative of a variation of a 2D feature value (e.g. data dependent on time and space/location).

Illustrative embodiments may therefore provide concepts for spatio-temporal prediction from diverse data sources. A spatio-temporal deep learning-based architecture may therefore be provided by proposed embodiments.

Modifications and additional steps to a traditional spatio-temporal prediction implementation may also be proposed which may enhance the value and utility of the proposed concepts.

Illustrative embodiments may be utilized in many different types of distributed processing environments. In order to provide a context for the description of elements and functionality of the illustrative embodiments, the figures are provided hereafter as an example environment in which aspects of the illustrative embodiments may be implemented. It should be appreciated that the figures are only exemplary and not intended to assert or imply any limitation with regard to the environments in which aspects or embodiments of the present invention may be implemented. Many modifications to the depicted environments may be made without departing from the spirit and scope of the present invention.

Also, those of ordinary skill in the art will appreciate that the hardware and/or architectures in the Figures may vary depending on the implementation. Further, the processes of the illustrative embodiments may be applied to multiprocessor/server systems, other than those illustrated, without departing from the scope of the proposed concepts.

Moreover, a system may take the form of any of a number of different processing devices including client computing devices, server computing devices, a tablet computer, laptop computer, telephone or other communication devices, personal digital assistants (PDAs), or the like. Thus, the system may essentially be any known or later-developed processing system without architectural limitation.

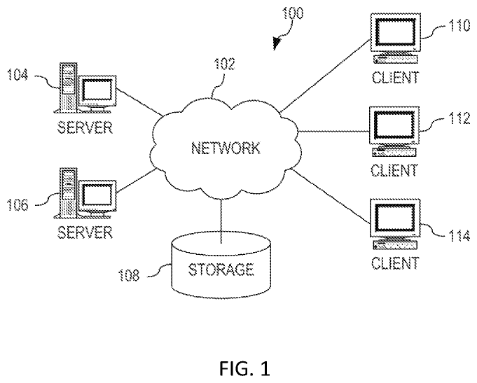

FIG. 1 depicts a pictorial representation of an exemplary distributed system in which aspects of the illustrative embodiments may be implemented. Distributed system 100 may include a network of computers in which aspects of the illustrative embodiments may be implemented. The distributed system 100 contains at least one network 102, which is the medium used to provide communication links between various devices and computers connected together within the distributed data processing system 100. The network 102 may include connections, such as wire, wireless communication links, or fiber optic cables.

In the depicted example, a first 104 and second 106 servers are connected to the network 102 along with a storage unit 108. In addition, clients 110, 112, and 114 are also connected to the network 102. The clients 110, 112, and 114 may be, for example, personal computers, network computers, or the like. In the depicted example, the first server 104 provides data, such as boot files, operating system images, and applications to the clients 110, 112, and 114. Clients 110, 112, and 114 are clients to the first server 104 in the depicted example. The distributed processing system 100 may include additional servers, clients, and other devices not shown.

In the depicted example, the distributed system 100 is the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

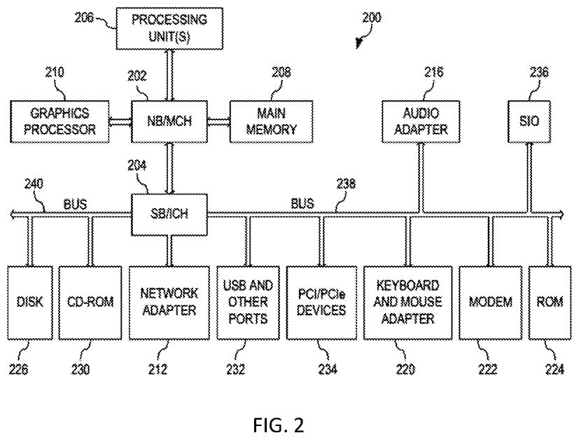

FIG. 2 is a block diagram of an example system 200 in which aspects of the illustrative embodiments may be implemented. The system 200 is an example of a computer, such as client 110 in FIG. 1, in which computer usable code or instructions implementing the processes for illustrative embodiments of the present invention may be located.

In the depicted example, the system 200 employs a hub architecture including a north bridge and memory controller hub (NB/MCH) 202 and a south bridge and input/output (I/O) controller hub (SB/ICH) 204. A processing unit 206, a main memory 208, and a graphics processor 210 are connected to NB/MCH 202. The graphics processor 210 may be connected to the NB/MCH 202 through an accelerated graphics port (AGP).

In the depicted example, a local area network (LAN) adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) ports and other communication ports 232, and PCl/PCIe devices 234 connect to the SB/ICH 204 through first bus 238 and second bus 240. PCl/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

An operating system runs on the processing unit 206. The operating system coordinates and provides control of various components within the system 200 in FIG. 2. As a client, the operating system may be a commercially available operating system. An object-oriented programming system, such as the Java™ programming system, may run in conjunction with the operating system and provides calls to the operating system from Java™ programs or applications executing on system 200.

As a server, system 200 may be, for example, an IBM® eServer™ System p® computer system, running the Advanced Interactive Executive (AIX®) operating system or the LINUX® operating system. The system 200 may be a symmetric multiprocessor (SMP) system including a plurality of processors in processing unit 206. Alternatively, a single processor system may be employed.

Instructions for the operating system, the programming system, and applications or programs are located on storage devices, such as HDD 226, and may be loaded into main memory 208 for execution by processing unit 206. Similarly, one or more message processing programs according to an embodiment may be adapted to be stored by the storage devices and/or the main memory 208.

The processes for illustrative embodiments of the present invention may be performed by processing unit 206 using computer usable program code, which may be located in a memory such as, for example, main memory 208, ROM 224, or in one or more peripheral devices 226 and 230.

A bus system, such as first bus 238 or second bus 240 as shown in FIG. 2, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the system mentioned previously, without departing from the spirit and scope of the present invention.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

According to various embodiments, a proposed concept may employ convolutional-based dense networks to model spatial dependencies between features. In this way, dependencies between regions in cities may be modelled for example. Also, several branches of a CNN may be employed for fusing various external data sources of differing dimensionality.

The architecture proposed may be expandable according to the availability of external data sources that need to be fused.

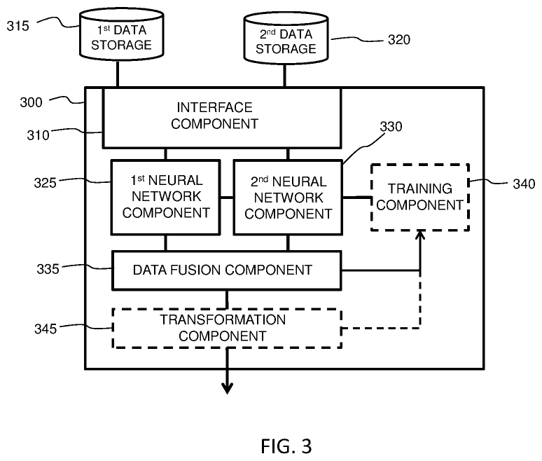

Accordingly, by way of example only, FIG. 3 is a simplified block diagram of a prediction system 300 for spatio-temporal prediction.

The system 300 comprises an interface component 310 configured to obtain, for each of one or more one-dimensional, 1D, features, a one-dimensional data matrix representative of a variation of the 1D feature value. The interface component 310 is also configured to obtain, for each of one or more two-dimensional, 2D, features, a two-dimensional data matrix representative of a variation of a 2D feature value.

In this example, a one-dimensional data matrix is representative of a variation of a 1D feature value with respect to time. A two-dimensional data matrix is representative of a variation of a 2D feature value with respect to time and space. Of course it will be appreciated that this is only exemplary, and that 1D and 2D feature value may vary with respect to other parameters.

Also, the example of FIG. 3, the interface component 310 is configured to obtain a first one-dimensional data matrix representative of a variation of a first 1D feature value from a first data storage component 315. Further, the interface component 310 is configured to obtain a second one-dimensional data matrix representative of a variation of a second 1D feature value from a second, different data storage component 320. Such data storage components 315, 320 may be local to, or remotely located from, the system 300. Thus, any suitable communication links and/or protocols may be employed to communicate data from the data storage components 315, 320.

The system 300 also comprises a first neural network component 325 that is configured to process each one-dimensional data matrix with a respective branch of a FCN so as to generate respective outputs from the FCN.

Also, the system 300 comprises a second neural network component 330 that is configured to process each two-dimensional data matrix with a CNN to generate respective outputs from the CNN.

The outputs from the FCN and CNN are provided to a data fusion component 335 of the system 300. The data fusion component 335 is configured to combine (i.e. fuse) the outputs from the FCN and CNN to generate an output prediction. In this way, the output prediction is based on a combination (i.e. fusion) of data from data sources of different dimensionality. Different dense networks are therefore employed in the example of FIG. 3 so as to model various spatial and temporal properties.

In the embodiment of FIG. 3, the data fusion component 335 is configured to weight the outputs from the fully connected network and convolutional neural network.

It is also noted that the embodiment of FIG. 3 comprises a training component 340 that is configured to train at least one of the first 325 and second 330 neural network components using a loss function and the generated output prediction. In his way a concept of feedback and comparison may be employed so as to train (e.g. modify and improve) the neural network components. However, as indicated by the dashed lines used to represent the training component 340, certain implementations of the system 300 of FIG. 3 may not employ the training component 340.

The system 300 of FIG. 3 also comprises a transformation component 345 that is configured to process the output prediction from the data fusion component 335 with a transformation function having an output range limited to predetermined range so as to translate the output prediction to a value within the predetermined range. For example, the predetermined range may be [−1, 1] and the transformation function may thus comprise one of sin, cos and tanh. Transforming the output prediction to a predetermined range may, for example, help to facilitate faster convergence in back-propagation learning (e.g. implemented via the training component 340). Again, the dashed lines used to represent the transformation component 345 indicate that some implementations of the system 300 of FIG. 3 may not employ the transformation component 345.

From the description provided thus far, it will be appreciated that there may be proposed a deep-learning based approach for forecasting spatio-temporal continuous values in each and every region of a city or a grid map. Such a deep-learning-based architecture may fuse external data sources of various dimensionalities (such as temporal functional regions, crowd mobility patterns, weather data in case of Network demand prediction problem, for example) to improve the accuracy of data prediction/forecasting. When compared to conventional approaches, the proposed approach may exhibit superior performance, confirming that it may be better and more applicable to spatio-temporal time series prediction/forecasting problems. Accordingly, the proposed architecture may be capable of learning spatial and temporal dependencies.

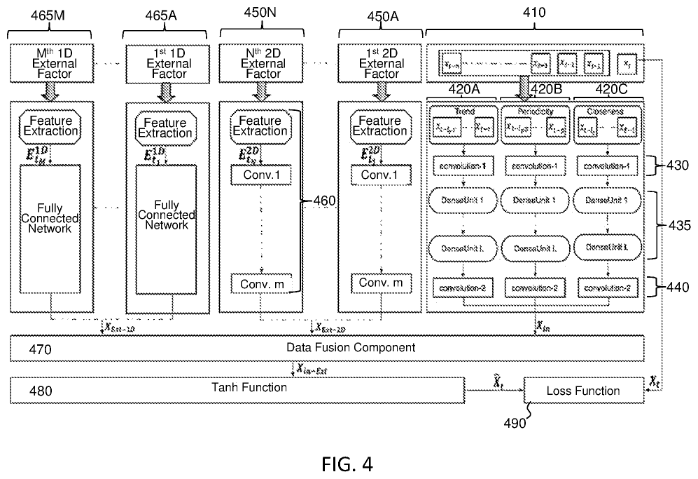

Referring now to FIG. 4, there is depicted a schematic block diagram of a proposed embodiment. Here, each of the inputs 410 required to be predicted at time t is converted to a 32×32 2-channel image-like matrix spanning over a region. Then the time axis is divided into three fragments denoting recent time, near history and distant history.

Next, these 2-channel image-like matrices are fed into three branches 420A, 420B, 420C (on the right side of the diagram) for capturing the trend, periodicity, and closeness and output Xᵢₙ . Each of these branches starts with convolution layer 430 followed by L dense blocks 435 and finally another convolution layer 440. These three convolutional based branches 420A, 420B, 420C capture the spatial dependencies between nearby and distant regions.

Also, there is are number of branches that fuse external factors based on their dimensionality. In this example of FIG. 4, the temporal functional regions and the crowd mobility patterns are 2-dimensional matrices (XExt-2D) that change across space and time. These 2-dimensional matrices (XExt-2D) are fed into respective branches 450A, 450N of a CNN. Each of these branches comprise m convolution layers 460. Further, the days of the week are 1-dimensional matrices that change across time only (XExt-1D) These 1-dimensional matrices are fed into respective branches 465A, 465M of a FCN.

A data fusion 470 layer then fuses the outputs X_{in′} XExt-2D, and XExt-1D. The output from the data fusion layer 470 is Xin-Ext which is fed to tanh function 480 to be mapped to [−1, 1] range. This helps in faster convergence in the back-propagation learning loss function 490 compared to a standard logistic function.

By way of further explanation, summary code for the procedures for training the proposed architecture depicted in FIG. 4 is provided as follows:

Input: Historical Observations: {X₀, ..., X_{8 - 1}};
External 1D Features (Eₜ^{1D}): {Eₜ₁^{1D}, ..., E_{tM}^{1D}};
External 2D Features (Eₜ^{2D}): {Eₜ₁^{2D}, ..., E_{tN}^{2D}};
lengths of closeness, period, trend sequences: l_{c}, lₚ, lᵣ
span of period, trend: p, r
Output: model M
// Construct training dataset
TR ← ∅
for 1 ≤ t ≤ s − 1 do

| | |
|---|---|
| \| | TD_{c} ← [X_{t-lc} , ...,Xₜ₋ₗ ] |
| \| | TDₚ ← [Xₜ₋ₗₚ p, ...,Xₜ₋ₚ ] |
| \| | TDᵣ ← [Xₜ₋ₗᵣ r..., Xₜ₋ᵣ ] |

create a sample of ({TD_{c}, TDₚ, TDᵣ, Eₜ^{1D}, Eₜ^{2D}}, Xₜ) in training data TD
end
// Train model M
Xᵢₙ^{c} ← DenseNet (TD_{c}), Xᵢₙ^{p} ← DenseNet (TDₚ), Xᵢₙ^{r} ← DenseNet (TDᵣ)
Xᵢₙ ← Xᵢₙ^{c} + Xᵢₙ^{p} + Xᵢₙ^{r}
X_{Ext-1D}¹,..., X_{Ext-1D}^{M} ← FCN (Eₜ₁^{1D}),..., FCN (E_{tM}^{1D})
X_{Ext-1D},..., ← X_{Ext-1D}¹ + ... + X_{Ext-1D}^{M}
X_{Ext-2D}¹,..., X_{Ext-2D}^{N} ← CNN (Eₜ₁^{2D}),..., CNN (E_{tM}^{2D})
X_{Ext-2D},..., ← X_{Ext-2D}¹ + ... + X_{Ext-2D}^{N}
X_{in-Ext} ← Xᵢₙ + X_{Ext-1D} + X_{Ext-2D}
\hat{X}ₜ ← tanh (X_{in-Ext})
// Optimize parameters ε for k, see equation 8.9
Initialize the parameters ε
for Stopping condition NOT met do

| | |
|---|---|
| \| | Select a batch of instances TD_{b} from TD |
| \| | Find parameters ε that minimizes k |

End
Conclude the learned model M

The effectiveness of the proposed model has been investigated by taking the network demand prediction problem as an example and fusing other various dimensional data sources including weather data, day of the week, mobility patterns, functional regions, with the network telco data for predicting network throughput uplink and downlink. The results from the investigations indicate the proposed concept surpasses all other (currently) popular time-series forecasting models. Specifically, the obtained results for a downlink throughput prediction demonstrates that the proposed approach (with 5 dense-blocks) is relatively 30% Root Mean Square Error (RMSE) and 20% Mean Absolute Error (MAE) better than the Naive model, 20% RMSE and 23% MAE better than ARIMA, 15% RMSE and 30% MAE better than RNN and 10% RMSE and 20% MAE better than LSTM. For the uplink throughput prediction, the proposed approach is 27% RMSE and 20% MAE better than the Naive model, 20% RMSE and 30% MAE better than ARIMA, 12% RMSE and 33% MAE better than RNN, and 10% RMSE and 30% MAE better than LSTM.

Also, there is a proposed an embodiment that does not consider external factors (e.g. temporal functional regions). Investigations have shown that such an approach is worse, thus indicating that external factors and patterns fused may be preferred.

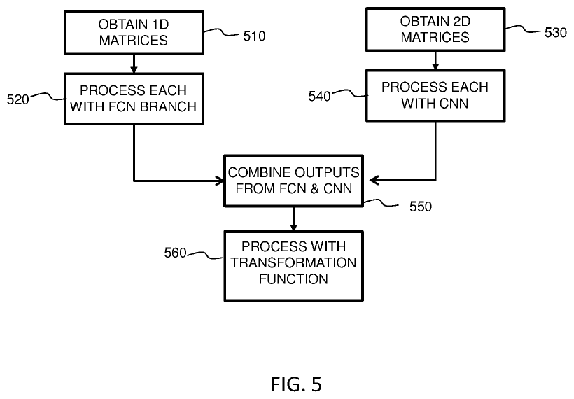

Referring now to FIG. 5, there is depicted a simplified flow-diagram of a computer-implemented method for spatio-temporal prediction according to an embodiment.

Step 510, comprises, for each of one or more one-dimensional, 1D, features, obtaining a one-dimensional data matrix representative of a variation of the 1D feature value. Here, a one-dimensional data matrix is representative of a variation of a 1D feature value with respect to time, and wherein

Each one-dimensional data matrix is then processed with a branch of a FCN in step 520, so as to generate respective outputs from the FCN.

The method also comprises steps 530 and 540 which may be undertaken before, after or during (i.e. in parallel with) steps 510 and/or 520.

Step 530 comprises, for each of one or more two-dimensional, 2D, features, obtaining a two-dimensional data matrix representative of a variation of a 2D feature value. Here, a two-dimensional data matrix is representative of a variation of a 2D feature value with respect to time and space. Each two-dimensional data matrix is then processed with a CNN in step 540 to generate respective outputs from the CNN.

Next, in step 550, the outputs from the FCN and CNN are combined to generate an output prediction. The output prediction is then processed with a transformation function in step 560. The transformation function has an output range limited to predetermined range, thus transforming the output prediction to a value within the predetermined range. As has already been mentioned above, the predetermined range may be [−1, 1] and the transformation function may thus comprise one of sin, cos and tanh. However, it will be appreciated that the transformation function implemented in step 500 may be configured so as to any suitable/required output range.

Although not shown in FIG. 5, alternative version of the proposed method may include additional steps, such as: obtaining a two-dimensional training matrix representative of an historical variation of a 2D feature value; processing the two-dimensional training matrix with first to third machine learning processes to determine a trend, periodicity and closeness measure, respectively; and determining a training prediction based on the determined trend, periodicity and closeness measure.

Such a training prediction may then be used to generate more accurate predictions. For example, the step 550 of combining the outputs from the FCN and CNN may further combine the training prediction to generate an output prediction.

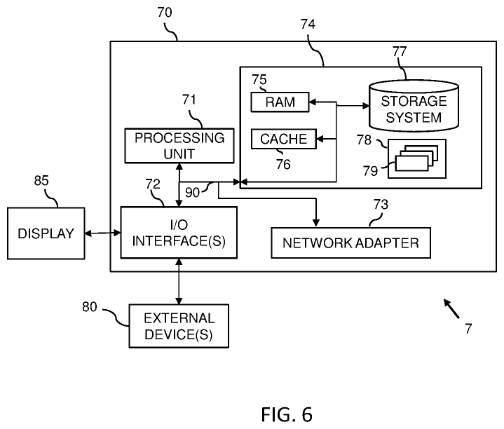

By way of further example, as illustrated in FIG. 6, embodiments may comprise a computer system 70, which may form part of a networked system 7. The components of computer system/server 70 may include, but are not limited to, one or more processing arrangements, for example comprising processors or processing units 71, a system memory 74, and a bus 90 that couples various system components including system memory 74 to processing unit 71.

Bus 90 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 70 typically includes a variety of computer system readable media. Such media may be any available media that is accessible by computer system/server 70, and it includes both volatile and non-volatile media, removable and non-removable media.

System memory 74 can include computer system readable media in the form of volatile memory, such as random access memory (RAM) 75 and/or cache memory 76. Computer system/server 70 may further include other removable/non-removable, volatile/non-volatile computer system storage media. By way of example only, storage system 74 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 90 by one or more data media interfaces. As will be further depicted and described below, memory 74 may include at least one program product having a set (e.g., at least one) of program modules that are configured to carry out the functions of embodiments of the invention.

Program/utility 78, having a set (at least one) of program modules 79, may be stored in memory 74 by way of example, and not limitation, as well as an operating system, one or more application programs, other program modules, and program data. Each of the operating system, one or more application programs, other program modules, and program data or some combination thereof, may include an implementation of a networking environment. Program modules 79 generally carry out the functions and/or methodologies of embodiments of the invention as described herein. #

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73. As depicted, network adapter 73 communicates with the other components of computer system/server 70 via bus 90. It should be understood that although not shown, other hardware and/or software components could be used in conjunction with computer system/server 70. Examples, include, but are not limited to: microcode, device drivers, redundant processing units, external disk drive arrays, RAID systems, tape drives, and data archival storage systems, etc.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for spatio-temporal prediction based on one-dimensional features and two-dimensional features from diverse data sources, the method comprising:
for each of one or more one-dimensional, 1D, features, obtaining a one-dimensional data matrix representative of a variation of the 1D feature value;
for each of one or more two-dimensional, 2D, features, obtaining a two-dimensional data matrix representative of a variation of a 2D feature value;
processing each one-dimensional data matrix with a branch of a fully connected network to generate respective outputs from the fully connected network;
processing each two-dimensional data matrix with a convolutional neural network to generate respective outputs from the convolutional neural network; and
combining, in a data fusion layer, the outputs from the fully connected network and convolutional neural network to generate an output prediction.

2. The method of claim 1, further comprising:
training at least one of the fully connected network and convolutional neural network using a loss function and the generated output prediction.

3. The method of claim 1, wherein a one-dimensional data matrix is representative of a variation of a 1D feature value with respect to time or space, and wherein a two-dimensional data matrix is representative of a variation of a 2D feature value with respect to time and space.

4. The method of claim 1, wherein a first one-dimensional data matrix representative of a variation of a first 1D feature value is obtained from a first data source and wherein a second one-dimensional data matrix representative of a variation of a second 1D feature value is obtained from a second, different data source.

5. The method of claim 1, wherein a first two-dimensional data matrix representative of a variation of a first 2D feature value is obtained from a third data source and wherein a second two-dimensional data matrix representative of a variation of a second 2D feature value is obtained from a fourth, different data source.

6. The method of claim 1, wherein the step of combining comprises: weighting the outputs from the fully connected network and convolutional neural network.

7. The method of claim 1, further comprising
processing the output prediction with a transformation function having an output range limited to predetermined range so as to translate the output prediction to a value within the predetermined range.

8. The method of claim 7, wherein the predetermined range is [−1, 1] and wherein the transformation function comprises one of sin, cos and tanh.

9. The method of claim 1, further comprising:
obtaining a two-dimensional training matrix representative of an historical variation of a 2D feature value;
processing the two-dimensional training matrix with first to third machine learning processes to determine a trend, periodicity and closeness measure, respectively; and
determining a training prediction based on the determined trend, periodicity and closeness measure; and
wherein combining comprises combining: the outputs from the fully connected network and convolutional neural network; and the the training prediction to generate an output prediction.

10. The method of claim 9, wherein at least one of the first to third machine learning processes comprises: applying a convolution process to the two-dimensional training matrix.

11. The method of claim 9, wherein the two-dimensional training matrix is representative of a historical variation of the 2D feature value with respect to time and space.

12. A computer program product for spatio-temporal prediction based on one-dimensional features and two-dimensional features from diverse data sources, the computer program product comprising a computer readable storage medium having program instructions embodied therewith, the program instructions executable by a processing unit to cause the processing unit to perform a method comprising:
for each of one or more one-dimensional, 1D, features, obtaining a one-dimensional data matrix representative of a variation of the 1D feature value;
for each of one or more two-dimensional, 2D, features, obtaining a two-dimensional data matrix representative of a variation of a 2D feature value;
processing each one-dimensional data matrix with a branch of a fully connected network to generate respective outputs from the fully connected network;
processing each two-dimensional data matrix with a convolutional neural network to generate respective outputs from the convolutional neural network; and
combining, in a data fusion layer, the outputs from the fully connected network and convolutional neural network to generate an output prediction.

13. A processing system comprising at least one processor and the computer program product of claim 12, wherein the at least one processor is adapted to execute the computer program code of said computer program product.

14. A prediction system for spatio-temporal prediction based on one-dimensional features and two-dimensional features from diverse data sources, the system comprising:
an interface component configured to obtain, for each of one or more one-dimensional, 1D, features, a one-dimensional data matrix representative of a variation of the 1D feature value, and to obtain, for each of one or more two-dimensional, 2D, features, a two-dimensional data matrix representative of a variation of a 2D feature value;
a first neural network component configured to process each one-dimensional data matrix with a branch of a fully connected network to generate respective outputs from the fully connected network;
a second neural network component configured to process each two-dimensional data matrix with a convolutional neural network to generate respective outputs from the convolutional neural network; and
a data fusion component configured to combine the outputs from the fully connected network and convolutional neural network to generate an output prediction.

15. The system of claim 14, further comprising:
a training component configured to train at least one of the fully connected network and convolutional neural network using a loss function and the generated output prediction.

16. The system of claim 14, wherein a one-dimensional data matrix is representative of a variation of a 1D feature value with respect to time or space, and wherein a two-dimensional data matrix is representative of a variation of a 2D feature value with respect to time and space.

17. The system of claim 14, wherein the interface component is configured to obtain a first one-dimensional data matrix representative of a variation of a first 1D feature value from a first data source and further configured to obtain a second one-dimensional data matrix representative of a variation of a second 1D feature value from a second, different data source.

18. The system of claim 14, wherein the interface component is configured to obtain a first two-dimensional data matrix representative of a variation of a first 2D feature value from a third data source and further configured to obtain a second two-dimensional data matrix representative of a variation of a second 2D feature value from a fourth, different data source.

19. The system of claim 14, wherein the data fusion component is configured to weight the outputs from the fully connected network and convolutional neural network.

20. The system of claim 14, further comprising:
a transformation component configured to process the output prediction with a transformation function having an output range limited to predetermined range so as to translate the output prediction to a value within the predetermined range.

21. The system of claim 20, wherein the predetermined range is [−1, 1] and wherein the transformation function comprise one of sin, cos and tanh.
